(19) United States
(12) Patent Application Publication
(10) Pub. No.: US 2025/0233670 A1
(43) Pub. Date: Jul. 17, 2025

(54) OPTICAL TRANSMITTER, OPTICAL RECEIVER, OPTICAL TRANSMISSION METHOD AND OPTICAL RECEPTION METHOD

(71) Applicant: NIPPON TELEGRAPH AND TELEPHONE CORPORATION, Tokyo (JP)

(72) Inventors: Fukutaro HAMAOKA, Musashino-shi (JP); Masanori NAKAMURA, Musashino-shi (JP); Takayuki KOBAYASHI, Musashino-shi (JP); Munehiko NAGATANI, Musashino-shi (JP); Hitoshi WAKITA, Musashino-shi (JP); Hiroshi YAMAZAKI, Musashino-shi (JP); Yoshihiro OGISO, Musashino-shi (JP); Yutaka MIYAMOTO, Musashino-shi (JP)

(73) Assignee: NIPPON TELEGRAPH AND TELEPHONE CORPORATION, Tokyo (JP)

(21) Appl. No.: 18/730,707

(22) PCT Filed: Jan. 25, 2022
(86) PCT No.: PCT/JP2022/002651

§ 371 Date: Jul. 19, 2024

(51) Int. Cl. H04B 10/50; H04B 10/61; H04J 14/02

(52) U.S. Cl. CPC H04B 10/501; H04B 10/61; H04J 14/0202

(57) ABSTRACT

An optical transmitter includes a multiplexed signal generation unit that multiplexes a plurality of narrowband signals and generates a broadband optical modulated signal; and a semiconductor optical amplifier that amplifies intensity of the broadband optical modulated signal.

### TECHNICAL FIELD

The present invention relates to an optical transmitter, an optical receiver, an optical transmission method, and an optical reception method.

### BACKGROUND ART

As the capacity of optical transmission systems increases, the size and power consumption of optical transceivers increase. In order to reduce the size and power consumption of an optical transceiver, research and development of an integrated optical module called an integrated coherent transmit-receiver optical subassembly (IC-TROSA) in which a wavelength tunable laser, a driver amplifier, an optical modulator, a light receiving element, and the like are integrally mounted have been advanced (see Non Patent Literature 1).

Since a semiconductor optical amplifier (SOA) is compact and has low power consumption, it can be used as an optical preamplifier in an optical module such as an IC-TROSA. Non Patent Literature 2 describes a configuration in which a semiconductor optical amplifier is incorporated as an optical preamplifier of an IC-TROSA having a data transmission rate of 400-600 Gb/s and a symbol rate of 64 GBd.

### CITATION LIST

### Non Patent Literature

Non Patent Literature 1: Implementation Agreement for Integrated Coherent Transmit-Receive Optical Sub Assembly,” OIF-IC-TROSA
Non Patent Literature 2: J. Zhou, et al., “Characterizations of Semiconductor Optical Amplifiers for 64Gbaud 16-64QAM Coherent Optical Transceivers,” OFC2019, Tu2H.7
Non Patent Literature 3: A. A. M. Saleh, “Nonlinear Models of Travelling-wave Optical Amplifiers,” Electronics Letters, vol. 24, no. 14, pp. 835-837, 1988.
Non Patent Literature 4: N. Kamitani, Y. Yoshida, and K. Kitayama, “Experimental Study on Impact of SOA Nonlinear Phase Noise in 40 Gbps Coherent 16QAM Transmissions,” ECOC2012, P1.04.
Non Patent Literature 5: S. Okamoto, M. Yoshida, K. Yonenaga, and T. Kataoka. “Adaptive Pre-equalization using Bidirectional Pilot Sequences to Estimate and Feed Back Amplitude Transfer Function and Chromatic Dispersion,” OFC2015 Th2A.29.

### SUMMARY OF INVENTION

### Technical Problem

However, the symbol rate of the optical modulated signal handled by the optical transceiver is usually several tens of GBd. The variation time of the optical modulated signal is a reciprocal of the symbol rate, and is about several tens of ps. Since the carrier lifetime of the semiconductor optical amplifier is usually several hundred ps and is a value close to the variation time of the optical modulated signal, nonlinear distortion caused by the semiconductor optical amplifier may occur in the optical modulated signal. Under such conditions, when the injection current into the semiconductor optical amplifier is increased and the semiconductor optical amplifier is driven with a high optical gain, nonlinear distortion caused by the semiconductor optical amplifier increases, which causes significant performance degradation of the optical modulated signal.

An object of the present invention is to provide a technique capable of reducing the influence of nonlinear distortion caused by a semiconductor optical amplifier.

### Solution to Problem

One aspect of the present invention is an optical transmitter including: a multiplexed signal generation unit that multiplexes a plurality of narrowband signals and generates a broadband optical modulated signal; and a semiconductor optical amplifier that amplifies an intensity of the broadband optical modulated signal.

One aspect of the present invention is an optical receiver including: a semiconductor optical amplifier that amplifies an intensity of a broadband optical modulated signal; and a multiplexed signal separation unit that separates the broadband optical modulated signal into a narrowband signal.

One aspect of the present invention is an optical transmission method including: a multiplexed signal generation step of multiplexing a plurality of narrowband signals and generating a broadband optical modulated signal; and a semiconductor optical amplification step of amplifying an intensity of the broadband optical modulated signal.

One aspect of the present invention is an optical reception method including: a semiconductor optical amplification step of amplifying an intensity of a broadband optical modulated signal; and a multiplexed signal separation step of separating the broadband optical modulated signal into a narrowband signal.

### Advantageous Effects of Invention

The technique of the present invention can reduce the influence of nonlinear distortion caused by the semiconductor optical amplifier.

### BRIEF DESCRIPTION OF DRAWINGS

FIG. 1 is a diagram illustrating a configuration of an optical transmission system 1 according to a first embodiment.

FIG. 2 is a diagram illustrating a configuration of an optical transmitter 2 according to the first embodiment.

FIG. 3 is a flowchart illustrating an operation of the optical transmitter 2 according to the first embodiment.

FIG. 4 is a modification of the optical transmitter 2 according to the first embodiment.

FIG. 5 is a diagram illustrating a configuration of an optical receiver 4 according to the first embodiment.

FIG. 6 is a flowchart illustrating an operation of the optical receiver 4 according to the first embodiment.

FIG. 7 is a modification of the optical receiver 4 according to the first embodiment.

FIG. 8 is a diagram illustrating a configuration of an optical transmitter 2 according to a second embodiment.

FIG. 9 is a flowchart illustrating an operation of the optical transmitter 2 according to the second embodiment.

FIG. 10 is a diagram illustrating a configuration of an optical receiver 4 according to the second embodiment.

FIG. 11 is a flowchart illustrating an operation of the optical receiver 4 according to the second embodiment.

FIG. 12 is a diagram illustrating configurations of a digital signal processing unit 21 and a digital signal processing unit 43 according to a third embodiment.

FIG. 13 is a table illustrating a constellation diagram under each condition.

FIG. 14 is a graph illustrating a relationship between a magnitude of an injection current (SOA injection current) into the semiconductor optical amplifier and an SNR penalty.

FIG. 15 is a diagram illustrating an optical transceiver 100 according to the present embodiment.

FIG. 16 is a diagram illustrating the optical transceiver 100 that performs polarization multiplexing according to the present embodiment.

### DESCRIPTION OF EMBODIMENTS

### First Embodiment

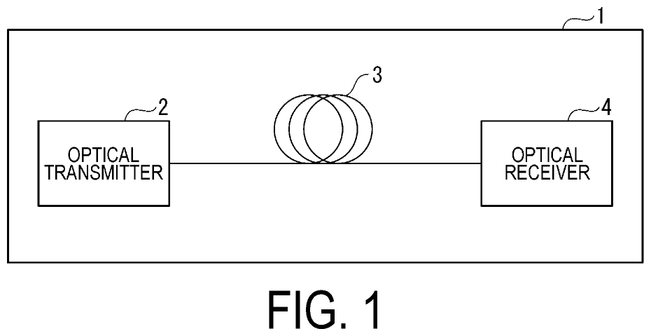

FIG. 1 is a diagram illustrating a configuration of an optical transmission system 1 according to a first embodiment. The optical transmission system 1 is a communication device using an optical signal. The optical transmission system includes an optical transmitter 2, a transmission path 3, and an optical receiver 4. The optical transmitter 2 is a communication device that transmits an optical signal. The transmission path 3 transmits an optical signal transmitted from the optical transmitter 2 to the optical receiver 4. The optical receiver 4 is a communication device that receives an optical signal.

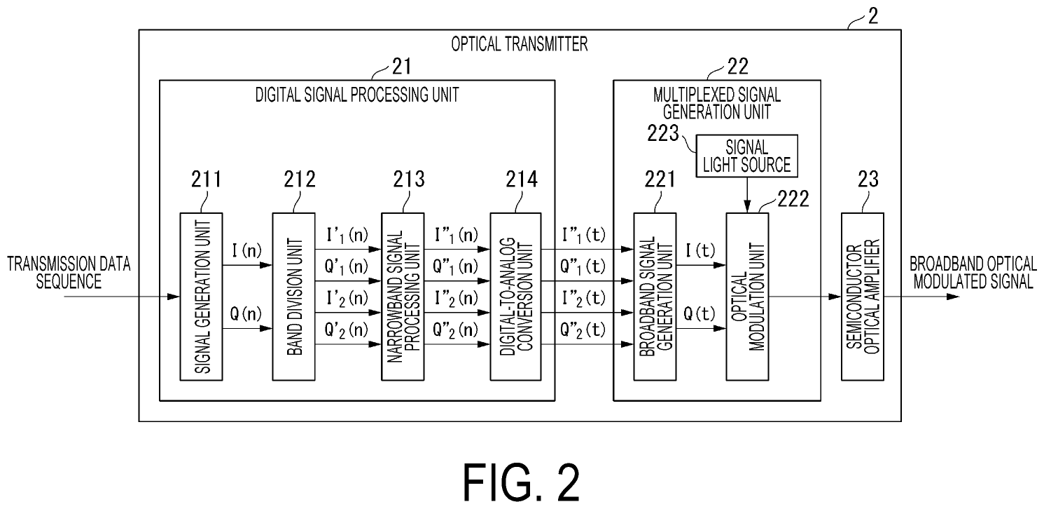

FIG. 2 is a diagram illustrating a configuration of the optical transmitter 2 according to the first embodiment. The optical transmitter 2 includes a digital signal processing unit 21, a multiplexed signal generation unit 22, and a semiconductor optical amplifier 23. The multiplexed signal generation unit 22 is realized by a broadband signal generation unit 221, an optical modulation unit 222, and a signal light source 223.

The digital signal processing unit 21 includes a signal generation unit 211, a band division unit 212, a narrowband signal processing unit 213, and a digital-to-analog conversion unit 214. The signal generation unit 211 generates a modulated signal sequence (I(n),Q(n)) from a transmission data sequence which is binary information. I(n) and Q(n) are electrical signals indicating an in-phase component and a quadrature component of the modulated signal. The signal generation unit 211 outputs the generated modulated signal sequence (I(n), Q(n)) to the band division unit 212. The band division unit 212 divides the modulated signal sequence input from the signal generation unit 211 into narrowband signals and inputs the narrowband signals to the narrowband signal processing unit 213. The narrowband signal is a signal having a band narrower than that of the modulated signal sequence. The narrowband signal processing unit 213 performs addition and subtraction processing of narrowband signals, and inputs the narrowband signals to the digital-to-analog conversion unit 214.

The digital-to-analog conversion unit 214 converts the modulated signal sequence input from the narrowband signal processing unit 213 into an analog signal. The digital-to-analog conversion unit 214 outputs the converted analog signal sequences (I₁″(t),Q₁″(t)) and (I₂″(t),Q₂″(t)) to the broadband signal generation unit 221.

The broadband signal generation unit 221 generates a broadband signal from a plurality of narrowband analog signals input from the digital-to-analog conversion unit 214 after being processed in advance by a band division unit 212 and a narrowband signal processing unit 213.

The division of the modulated signal sequence into the narrowband signal in the band division unit 212, the addition and subtraction processing of the narrowband signals in the narrowband signal processing unit 213, and the generation of the broadband signal from the plurality of narrowband analog signals in the broadband signal generation unit 221 can be performed by an arbitrary method. For example, using the method disclosed in Japanese Patent Application Laid-Open No. 2018-019255, the following processing is performed.

The band division unit 212 divides the modulated signal sequence (I(n), Q(n)) input from the signal generation unit 211 into an upper side waveband and a lower side waveband and performs frequency shift. The band division unit 212 outputs the frequency-shifted upper side waveband signals (narrowband signals, (I₁′(n), Q₁′(n)) and lower side waveband signals (narrowband signals (I₂′(n), Q₂′(n)) to the narrowband signal processing unit 213, respectively.

The narrowband signal processing unit 213 performs at least one of addition and subtraction processing of the upper side waveband and the lower side waveband on the upper side waveband signal and the lower side waveband signal input from the band division unit 212. The narrowband signal processing unit 213 outputs the narrowband signals (I₁″(n), Q₁″(n), and (I₂″(n), Q₂″(n)) subjected to at least one of the addition and subtraction processes to the digital-to-analog conversion unit 214.

The broadband signal generation unit 221 performs frequency shift on each of the plurality of analog signals input from the digital-to-analog conversion unit 214. The broadband signal generation unit 221 performs processing of adding a plurality of frequency-shifted analog signals to generate a broadband signal. The band of the broadband signal is larger than the band of the analog signal to be added. The broadband signal generation unit 221 outputs the generated broadband signal (I(t),Q(t)) to the optical modulation unit 222. Since the broadband signal (I(t),Q(t)) is generated by adding a plurality of different frequency-shifted analog signal sequences, the frequency band of the broadband signal sequence is wider than the frequency band of the analog signal sequence.

The optical modulation unit 222 modulates the optical signal that serves as a carrier wave output from the signal light source 223 with the broadband signal input from the broadband signal generation unit 221 to generate a broadband optical modulated signal. The optical modulation unit 222 outputs the generated broadband optical modulated signal to the semiconductor optical amplifier 23.

The semiconductor optical amplifier 23 amplifies the intensity of the broadband optical modulated signal input from the optical modulation unit 222. The semiconductor optical amplifier 23 outputs the amplified optical modulated signal to the optical receiver 4 via the transmission path 3.

Note that the modulated signal sequence may be divided into three or more narrowband signals and output from the digital-to-analog conversion unit to generate a broadband optical modulated signal.

A driver amplifier may be inserted between the broadband signal generation unit 221 and the optical modulation unit 222 to amplify the broadband signal. The multiplexed signal generation unit 22 may have a configuration in which the broadband signal generation unit 221 and the optical modulation unit 222 are integrated. The signal light source 223 and the driver amplifier may be added to and integrated with the integrated multiplexed signal generation unit 22. The narrowband signal processing unit 213 may be an analog circuit and may be inserted between the digital-to-analog conversion unit 214 and the broadband signal generation unit 221. Furthermore, the narrowband signal processing unit 213 may be added to and integrated with the integrated multiplexed signal generation unit 22.

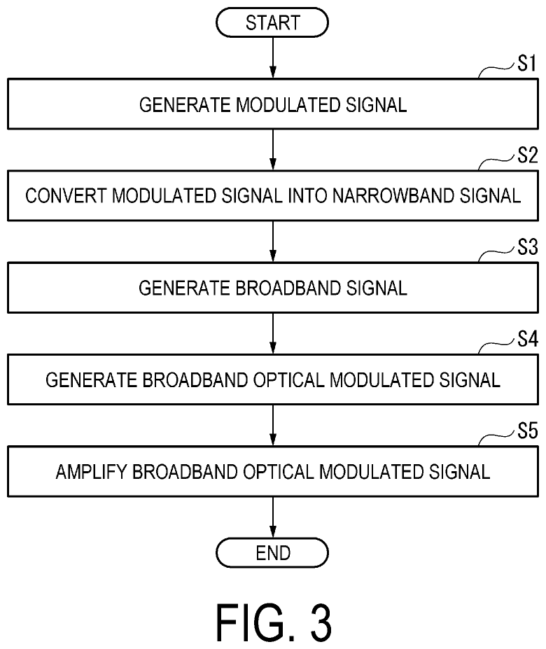

FIG. 3 is a flowchart illustrating an operation of the optical transmitter 2 according to the first embodiment. The signal generation unit 211 generates a modulated signal (step S1). The band division unit 212 converts the modulated signal into a narrowband signal (step S2). The broadband signal generation unit 221 generates a broadband signal based on a plurality of narrowband signals (step S3). The optical modulation unit 222 generates a broadband optical modulated signal based on the broadband signal (step S4). The semiconductor optical amplifier 23 amplifies the broadband optical modulated signal (step S5).

As described above, the optical transmitter 2 according to the first embodiment generates a broadband signal having a wider band than the narrowband signal based on the plurality of narrowband signals. Since the variation time of the broadband optical modulated signal is equal to the reciprocal of the optical signal band, the broadband optical modulated signal generated based on the broadband signal is a signal having a variation time shorter than that of the optical modulated signal generated based on a signal having a band narrower than the broadband signal. Therefore, the optical transmitter 2 according to the first embodiment can make the variation time of the optical modulated signal sufficiently shorter than the carrier lifetime of the semiconductor optical amplifier. Therefore, the optical transmitter 2 according to the first embodiment can reduce the influence of the nonlinear distortion caused by the semiconductor optical amplifier.

In order to generate a broadband signal, a digital-to-analog converter (DAC) and an analog-to-digital converter (ADC) capable of operating at a high speed are essential, but the DAC and the ADC created using a complementary metal oxide semiconductor (CMOS) platform have an analog output band of about 30 GHz, which is insufficient. However, the broadband signal generated by the optical transmitter 2 according to the first embodiment has a sufficiently wide band.

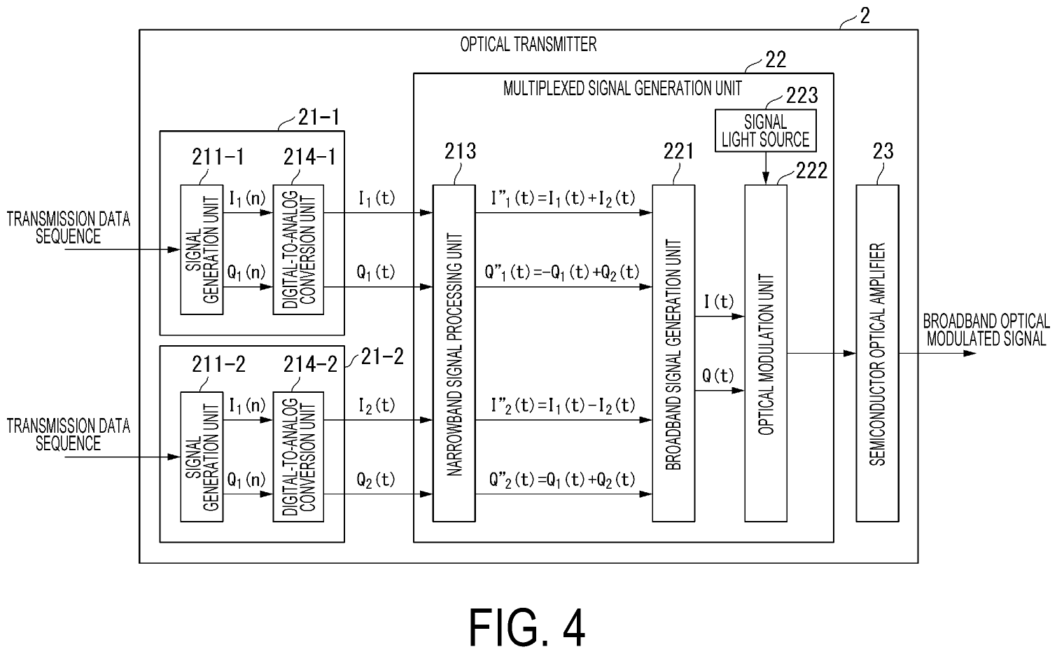

The optical transmitter 2 according to the first embodiment may have the configuration illustrated in FIG. 4. As illustrated, in the optical transmitter 2 according to the first embodiment, independent narrowband signals may be output from a plurality of digital signal processing units (the digital signal processing unit 21-1 and the digital signal processing unit 21-2), respectively, and a broadband signal generated based on the independent narrowband signals may be generated.

As illustrated in FIG. 4, the optical transmitter 2 according to the first embodiment may include two digital signal processing units 21 (21-1, 21-2) including a signal generation unit 211 and a digital-to-analog conversion unit 214, and a multiplexed signal generation unit 22 including a narrowband signal processing unit 213, a broadband signal generation unit 221, an optical modulation unit 222, and a signal light source 223.

The signal generation unit 211-1 of the digital signal processing unit 21-1 may generate a modulated signal sequence (I₁(n), Q₁(n)) that is a narrowband signal from a transmission data sequence that is binary information. The signal generation unit 211-1 of the digital signal processing unit 21-1 may output the generated modulated signal sequence (I₁(n), Q₁(n)) to the digital-to-analog conversion unit 214-1.

Similarly, the signal generation unit 211-2 of the digital signal processing unit 21-2 may generate a modulated signal sequence (I₂(n), Q₂(n)) that is a narrowband signal from a transmission data sequence that is binary information. The signal generation unit 211-1 of the digital signal processing unit 21-2 may output the generated modulated signal sequence (I₂(n), Q₂(n)) to the digital-to-analog conversion unit 214-1.

The digital-to-analog conversion unit 214-1 of the digital signal processing unit 21-1 may convert the modulated signal sequence input from the signal generation unit 211-1 into an analog signal. The digital-to-analog conversion unit 214-1 of the digital signal processing unit 21-1 may output the converted analog signal (I₁(t), Q₁(t)) to the narrowband signal processing unit 213.

Similarly, the digital-to-analog conversion unit 214-2 of the digital signal processing unit 21-2 may convert the modulated signal sequence input from the signal generation unit 211-2 into an analog signal. The digital-to-analog conversion unit 214-2 of the digital signal processing unit 21-2 may output the converted analog signal (I₂(t), Q₂(t)) to the narrowband signal processing unit 213.

The narrowband signal processing unit 213 may perform at least one of addition and subtraction processing of narrowband signals that are analog signals input from the digital-to-analog conversion unit 214-1 of the digital signal processing unit 21-1 and the digital-to-analog conversion unit 214-2 of the digital signal processing unit 21-2, respectively.

The narrowband signal processing unit 213 may output the narrowband signals ((I₁″(t)=I₁(t)+I₂(t), Q₁″(t)=−Q₁(t)+Q₂(t)), (I₂″(t)=I₁(t)−I₂(t), Q₂′(t)=Q₁(t)+Q₂(t)) subjected to at least one of the addition and subtraction processes to the broadband signal generation unit 221.

When the optical transmitter 2 has the configuration illustrated in FIG. 4, the optical transmitter 2 does not need to perform the operation of converting the modulated signal into the narrowband signal (step S2 in the flowchart of FIG. 3). In addition, the optical transmitter 2 illustrated in FIG. 4 may include three or more digital signal processing units 21.

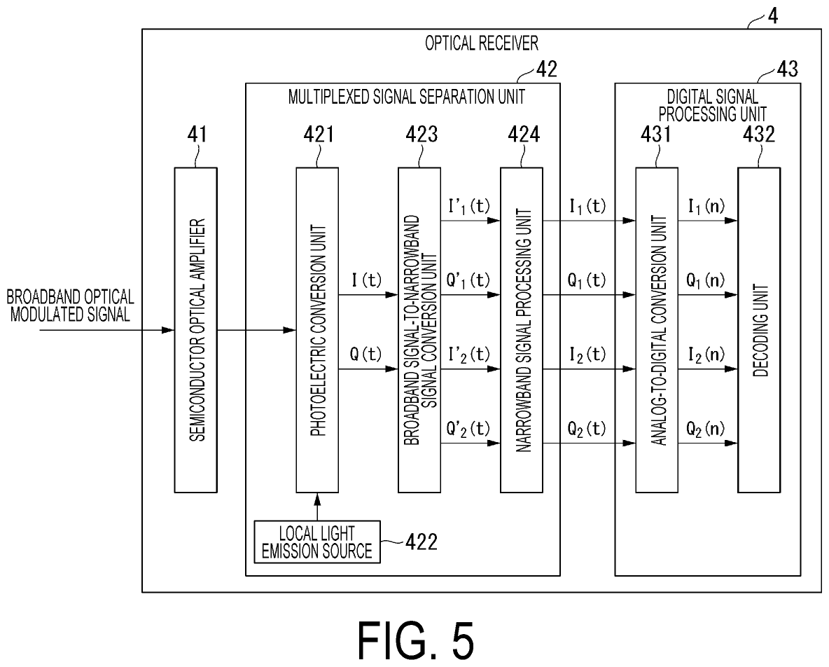

FIG. 5 is a diagram illustrating a configuration of the optical receiver 4 according to the first embodiment. The optical receiver 4 includes a semiconductor optical amplifier 41, a multiplexed signal separation unit 42, and a digital signal processing unit 43. The multiplexed signal separation unit 42 is realized by a photoelectric conversion unit 421, a local light emission source 422, a broadband signal-to-narrowband signal conversion unit 423, and a narrowband signal processing unit 424.

The semiconductor optical amplifier 41 amplifies the intensity of the broadband optical modulated signal received via the transmission path 3. The semiconductor optical amplifier 41 outputs the amplified optical signal to the photoelectric conversion unit 421.

The photoelectric conversion unit 421 converts the optical signal input from the semiconductor optical amplifier 41 into an electrical signal. The photoelectric conversion unit 421 converts the optical signal into a broadband signal (I(t), Q(t)) that is an analog signal by causing the broadband optical modulated signal input from the semiconductor optical amplifier 41 to interfere with the local light output from the local light emission source 422. The photoelectric conversion unit 421 outputs the electric signal to the broadband signal-to-narrowband signal conversion unit 423.

The photoelectric conversion unit 421 includes, for example, a 90 degree optical hybrid, a photodiode, and a transimpedance amplifier (TIA). The photoelectric conversion unit 421 generates interference light from an optical signal input from the semiconductor optical amplifier 41 and local light by, for example, 90 degree optical hybrid. The in-phase component and the quadrature component of the interference light are input to the photodiode, respectively. The current signal generated by the photodiode is converted into a voltage signal by the TIA, and the voltage signal is output to the broadband signal-to-narrowband signal conversion unit 423.

The broadband signal-to-narrowband signal conversion unit 423 separates the broadband signal into a plurality of narrowband signals and inputs the plurality of narrowband signals to the narrowband signal processing unit 424. The narrowband signal processing unit 424 performs signal processing on the narrowband signals and outputs the processed signals to the digital signal processing unit 43.

The separation of the broadband signal into the narrowband signal in the broadband signal-to-narrowband signal conversion unit 423 and the signal processing of the narrowband signals in the narrowband signal processing unit 424 can be performed by an arbitrary method. For example, when the method disclosed in WO 2019/031447 A is used, the following processing is performed.

The broadband signal-to-narrowband signal conversion unit 423 divides the broadband signal (I(t), Q(t)) input from the photoelectric conversion unit 421 into a plurality of (two in the present embodiment) broadband signals, respectively. The broadband signal-to-narrowband signal conversion unit 423 frequency-shifts a plurality of divided broadband signals to obtain narrowband signals. The broadband signal-to-narrowband signal conversion unit 423 outputs the plurality of frequency-shifted narrowband signals ((I₁′(t), Q₁′(t)), (I₂′(t), Q₂′(t)) to the narrowband signal processing unit 424, respectively. Each of the narrowband signals is expressed by (Expression 1).

$${I}_{1}^{′} ( t ) = {I}_{1} ( t ) + {I}_{2} ( t ) , \qquad ( Expression 1 )$$

$${Q}_{1}^{′} ( t ) = - {Q}_{1} ( t ) + {Q}_{2} ( t ) ,$$

$${I}_{2}^{′} ( t ) = {I}_{1} ( t ) - {I}_{2} ( t ) ,$$

$${Q}_{2}^{′} ( t ) = {Q}_{1} ( t ) + {Q}_{2} ( t ) ,$$

The narrowband signal processing unit 424 performs at least one of addition and subtraction processing of the plurality of narrowband signals that are input from the broadband signal-to-narrowband signal conversion unit 423. The narrowband signal processing unit 424 outputs a plurality of narrowband signals ((I₁(t), Q₁(t)), (I₂(t), Q₂(t)) subjected to at least one of addition and subtraction processing to an analog-to-digital conversion unit 431.

Note that the narrowband signal processing unit 424 may be included in a decoding unit 432 of the digital signal processing unit 43.

The digital signal processing unit 43 includes an analog-to-digital conversion unit 431 and a decoding unit 432. The analog-to-digital conversion unit 431 converts the narrowband analog signal sequence input from the multiplexed signal separation unit 42 into digital signal sequences ((I₁(n), Q₁(n)), (I₂(n), Q₂(n)) The decoding unit 432 converts a narrowband signal into a broadband signal, equalizes waveform distortions generated in the optical transmitter 2, the transmission path 3, and the optical receiver 4, and then decodes the digital signal sequence.

Note that the decoding unit 432 may be configured to independently equalize the waveform distortions generated in the narrowband signal in the optical transmitter 2, the transmission path 3, and the optical receiver 4 without converting the narrowband signal into the broadband signal, and then decode the digital signal sequence.

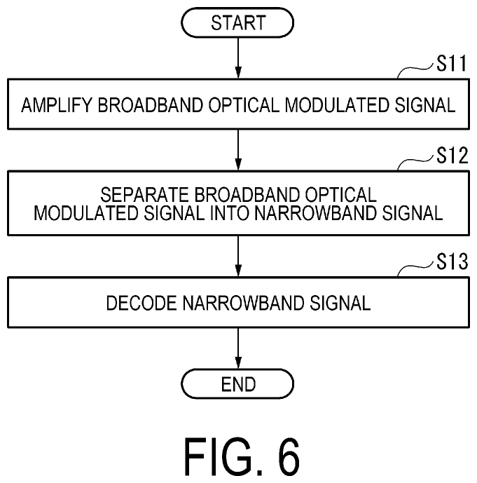

FIG. 6 is a flowchart illustrating an operation of the optical receiver 4 according to the first embodiment. The semiconductor optical amplifier 41 amplifies the broadband optical modulated signal, received by the optical receiver 4, with the semiconductor optical amplifier (step S11). The multiplexed signal separation unit 42 separates the broadband optical modulated signal into a narrowband signal (step S12). In the digital signal processing unit 43, the analog-to-digital conversion unit 431 converts the narrowband analog signal sequence into the digital signal sequence, and the decoding unit 432 decodes the narrowband signal (step S13).

In the optical transmission system 1 according to the first embodiment, since the frequency band of the optical signal transmitted by the optical transmitter 2 is a broadband, the influence of the nonlinear distortion caused by the semiconductor optical amplifier 23 included in the optical transmitter 2 and the semiconductor optical amplifier 41 included in the optical receiver 4 can be reduced.

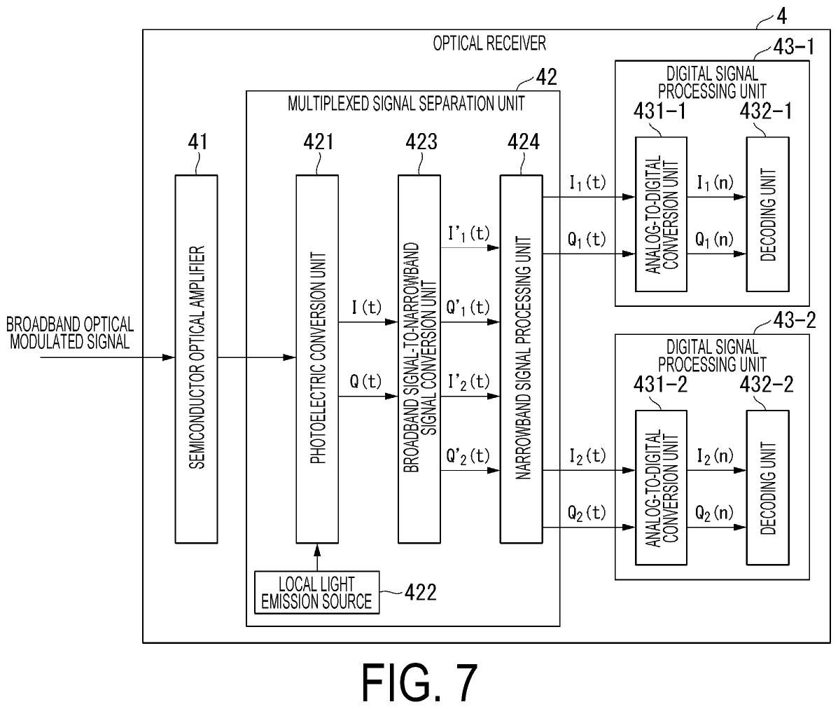

The optical receiver 4 according to the first embodiment may have the configuration illustrated in FIG. 7. As illustrated, the optical receiver 4 according to the first embodiment may include a plurality of digital signal processing units 43 (digital signal processing unit 43-1 and digital signal processing unit 43-2). In addition, the optical receiver 4 may include three or more digital signal processing units.

### Second Embodiment

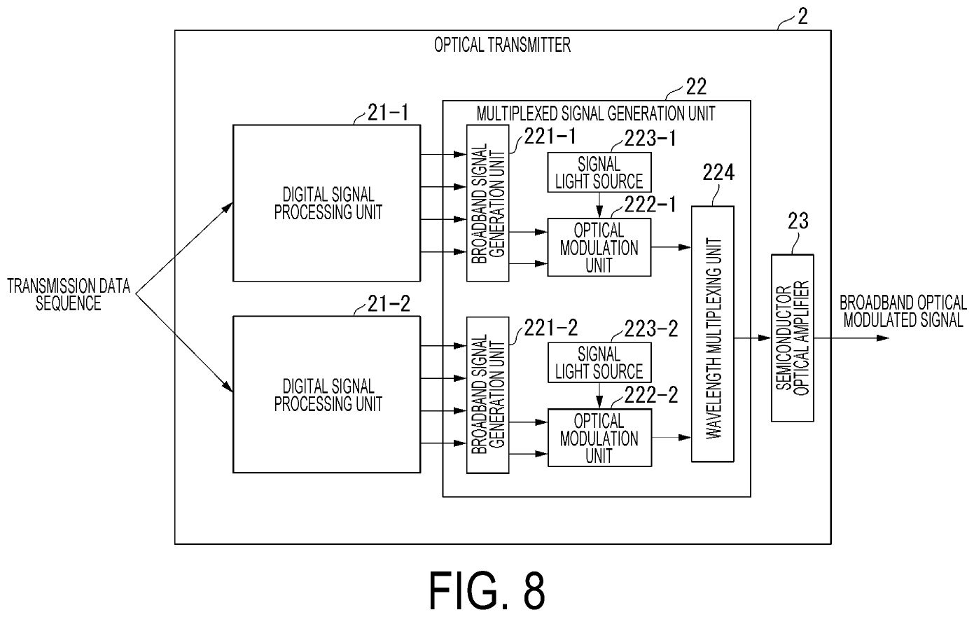

FIG. 8 is a diagram illustrating a configuration of an optical transmitter 2 according to a second embodiment. The optical transmitter 2 according to the second embodiment is different from the optical transmitter 2 according to the first embodiment in that a wavelength multiplexing unit multiplexes a plurality of optical modulated signals having different center wavelengths to generate a broadband optical modulated signal. The optical transmitter 2 according to the second embodiment includes a plurality of (two in the present embodiment) digital signal processing units 21. The configuration of each digital signal processing unit 21 according to the second embodiment is the same as that of the digital signal processing unit 21 according to the first embodiment, and includes a band division unit 212 and a narrowband signal processing unit 213. Note that, at this time, a plurality of digital signal processing units 21 may be integrated into one digital signal processing unit 21, and the band division unit 212 and the narrowband signal processing unit 213 may be included. Note that, in another embodiment, the plurality of digital signal processing units 21 may include only the signal generation unit 211 and the digital-to-analog conversion unit 214, and may perform DA conversion on I(n), Q(n) signals without dividing the band. In this case, the multiplexed signal generation unit 22 may not include the broadband signal generation unit 221, and may optically modulate and wavelength-multiplex each of a plurality of analog narrowband signals output from the plurality of digital signal processing units 21. Note that, at this time, the optical transmitter 2 may be configured to integrate a plurality of digital signal processing units 21 into one digital signal processing unit 21, include only the signal generation unit 211 and the digital-to-analog conversion unit 214, and output a plurality of narrowband signals.

The multiplexed signal generation unit 22 according to the second embodiment includes a plurality of (two in the present embodiment, respectively) broadband signal generation units 221, optical modulation units 222, and signal light sources 223, and includes a wavelength multiplexing unit 224. In addition, the optical transmitter 2 according to the second embodiment may not include the plurality of signal light sources 223, and the signal light source 223 may be used as a super continuum light source having a plurality of optical carrier waves to divide these carrier waves and output signal light to the plurality of optical modulation units 222.

The optical modulation unit 222 according to the second embodiment modulates each analog signal sequence input from the digital signal processing unit 21 and generates an optical modulated signal. The optical modulation unit 222 according to the second embodiment outputs the optical modulated signal to the wavelength multiplexing unit 224.

The wavelength multiplexing unit 224 multiplexes the optical modulated signals input from the plurality of optical modulation units 222 to generate a broadband optical modulated signal. The frequency band of the broadband optical modulated signal is larger than the frequency band of the optical modulated signal. The wavelength multiplexing unit 224 outputs the broadband optical modulated signal to the semiconductor optical amplifier 23.

The semiconductor optical amplifier 23 according to the second embodiment amplifies the intensity of the broadband optical modulated signal input from the wavelength multiplexing unit 224. The semiconductor optical amplifier 23 according to the second embodiment outputs the amplified optical signal to the optical receiver 4 via the transmission path 3.

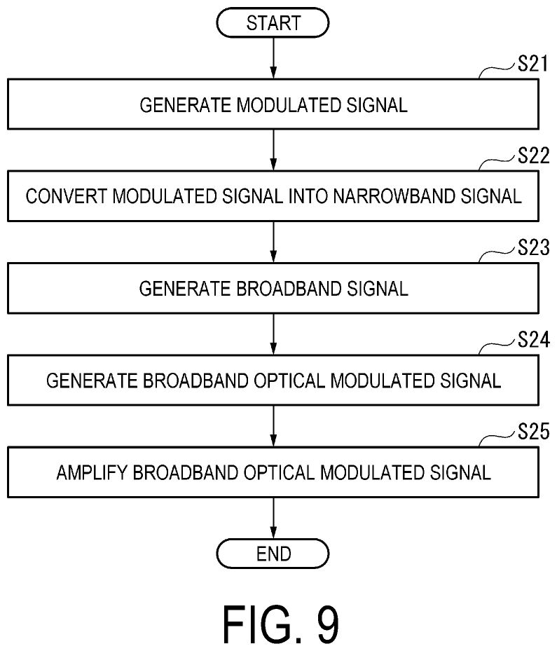

FIG. 9 is a flowchart illustrating an operation of the optical transmitter 2 according to the second embodiment. The signal generation unit 211 generates a modulated signal (step S21). The band division unit 212 converts the modulated signal into a narrowband signal (step S22). The broadband signal generation unit 221 generates a broadband signal based on a plurality of narrowband signals (step S23). The wavelength multiplexing unit 224 multiplexes the plurality of optical modulated signals output from the optical modulation unit 222 to generate a broadband optical modulated signal (step S24). The semiconductor optical amplifier 23 amplifies the broadband optical modulated signal (step S25).

Note that, as described above, in a case where the digital signal processing unit 21 includes only the signal generation unit 211 and the digital-to-analog conversion unit 214, and the multiplexed signal generation unit 22 does not include the broadband signal generation unit 221, step S22 can be omitted.

The optical transmitter 2 according to the second embodiment can generate an optical signal having a wide band by multiplexing the optical modulated signal by the wavelength multiplexing unit 224. Therefore, the variation time of the optical modulated signal handled by the optical transmitter 2 according to the second embodiment is shorter than the carrier lifetime of the semiconductor optical amplifier similarly to the optical transmitter 2 according to the first embodiment. Therefore, the optical transmitter 2 according to the second embodiment can reduce the influence of the nonlinear distortion caused by the semiconductor optical amplifier.

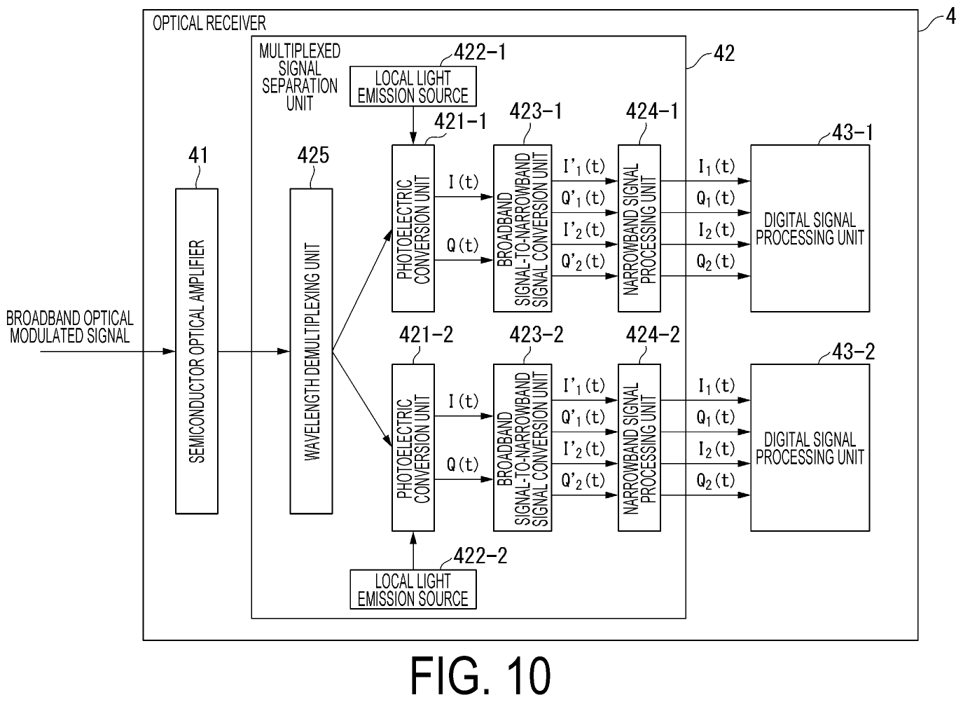

FIG. 10 is a diagram illustrating a configuration of an optical receiver 4 according to the second embodiment. The optical receiver 4 according to the second embodiment is different from the optical receiver 4 according to the first embodiment in that a wavelength demultiplexing unit 425 demultiplexes a broadband optical modulated signal to generate a narrowband signal. The optical receiver 4 according to the second embodiment includes a semiconductor optical amplifier 41, a multiplexed signal separation unit 42, and a plurality of (two in the present embodiment) digital signal processing units 43. The multiplexed signal separation unit 42 includes a wavelength demultiplexing unit 425, a plurality of (two in the present embodiment) photoelectric conversion units 421, a local light emission source 422, a broadband signal-to-narrowband signal conversion unit 423, and a narrowband signal processing unit 424. Each digital signal processing unit 43 according to the second embodiment has the same configuration as each of the digital signal processing unit 43 according to the first embodiment, and includes an analog-to-digital conversion unit 431 and a decoding unit 432. Note that, in another embodiment, the multiplexed signal separation unit 42 may include only the wavelength demultiplexing unit 425, the photoelectric conversion unit 421, and the local light emission source 422, and may output I(t), Q(t) signals without converting an analog signal into a narrowband signal. Note that, at this time, the optical receiver 4 may include one digital signal processing unit 43, and may perform AD conversion and decoding on the signal input from the photoelectric conversion unit 421. In addition, the optical receiver 4 according to the second embodiment may not include the plurality of local light emission source 422, and the local light emission source 422 may be used as a super continuum light source having a plurality of optical carrier waves to divide these carrier waves and output local light to the plurality of photoelectric conversion units 421.

The wavelength demultiplexing unit 425 demultiplexes the broadband optical modulated signal input from the semiconductor optical amplifier 41. The wavelength demultiplexing unit 425 outputs each of the demultiplexed optical signals to the corresponding photoelectric conversion units 421.

The photoelectric conversion unit 421 according to the second embodiment converts the optical signal input from the wavelength demultiplexing unit 425 into an electrical signal. The broadband signal-to-narrowband signal conversion unit 423 according to the second embodiment separates the broadband signal input from the photoelectric conversion unit 421 into a plurality of narrowband signals and inputs the plurality of narrowband signals to the narrowband signal processing unit 424. The narrowband signal processing unit 424 according to the second embodiment performs at least one of addition and subtraction processing of the plurality of narrowband signals input from the broadband signal-to-narrowband signal conversion unit 423. The analog-to-digital conversion unit 431 according to the second embodiment converts the narrowband analog signal sequence input from the multiplexed signal separation unit 42 into the digital signal sequence. The decoding unit 432 according to the second embodiment converts the narrowband signal into the broadband signal, equalizes waveform distortions generated in the optical transmitter 2, the transmission path 3, and the optical receiver 4, and then decodes the digital signal sequence.

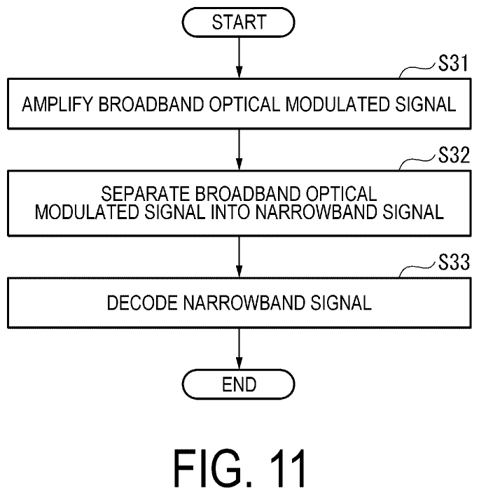

FIG. 11 is a flowchart illustrating an operation of the optical receiver 4 according to the second embodiment. The semiconductor optical amplifier 41 amplifies the broadband optical modulated signal received by the optical receiver 4 (step S31). The wavelength demultiplexing unit 425 included in the multiplexed signal separation unit 42 demultiplexes the broadband optical modulated signal and separates the resultant signals into narrowband signals (step S32). In the digital signal processing unit 43, the analog-to-digital conversion unit 431 converts the narrowband analog signal sequence into the digital signal sequence, and the decoding unit 432 decodes the narrowband signal (step S33).

In the optical transmission system 1 according to the second embodiment, similarly to the optical transmission system 1 according to the first embodiment, since the frequency band of the optical signal transmitted by the optical transmitter 2 is a broadband, the influence of the nonlinear distortion caused by the semiconductor optical amplifier 23 included in the optical transmitter 2 and the semiconductor optical amplifier 41 included in the optical receiver 4 can be reduced.

### Third Embodiment

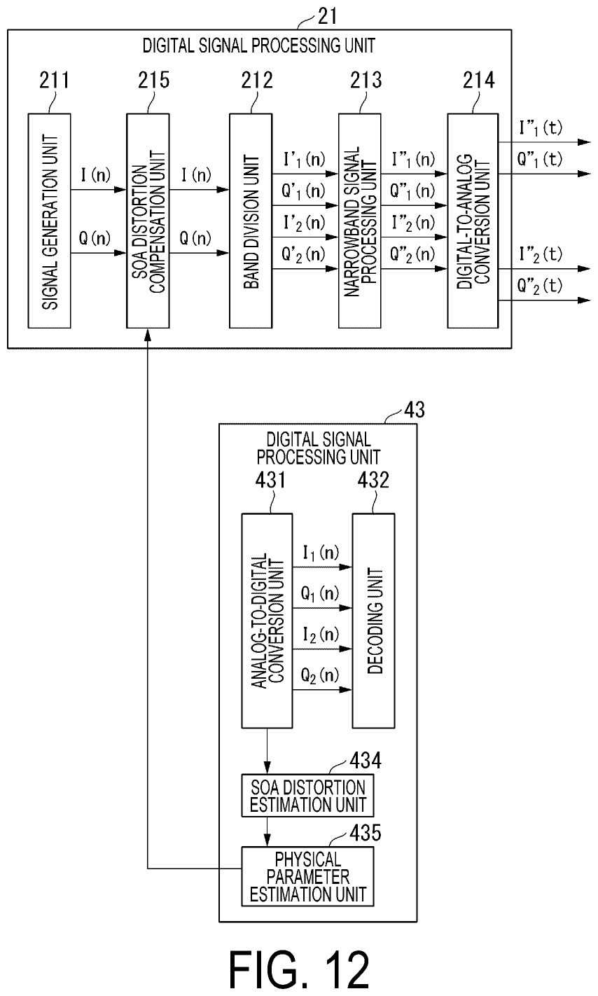

FIG. 12 is a diagram illustrating configurations of a digital signal processing unit 21 and a digital signal processing unit 43 according to a third embodiment. The digital signal processing unit 21 according to the third embodiment is different from the digital signal processing unit 21 according to the first embodiment or the second embodiment, and includes an SOA distortion compensation unit 215 in the digital signal processing unit 21. The digital signal processing unit 43 according to the third embodiment is different from the digital signal processing unit 43 according to the first embodiment or the second embodiment, and includes an SOA distortion estimation unit 434 and a physical parameter estimation unit 435. Note that, in a case where the physical parameters are known, the digital signal processing unit 43 according to the third embodiment may not include the SOA distortion estimation unit 434 and the physical parameter estimation unit 435. Any method can be used for the SOA distortion compensation unit 215, the SOA distortion estimation unit 434, and the physical parameter estimation unit 435. For example, distortion caused by the SOA can be compensated as follows by using the method described in Japanese Patent Application Laid-Open No. 2018-019255.

The SOA distortion compensation unit 215 compensates for distortion due to the semiconductor optical amplifier 23 for the modulated signal generated by the signal generation unit 211. The SOA distortion compensation unit 215 outputs the compensated signal to the band division unit 212.

The SOA distortion compensation unit 215 acquires estimated values of the physical parameters of the semiconductor optical amplifier 23 from the physical parameter estimation unit 435 of the optical receiver 4. The SOA distortion compensation unit 215 estimates nonlinear signal distortion generated in the optical signal input to the semiconductor optical amplifier 23 based on the estimated values of the physical parameters of the semiconductor optical amplifier 23, and compensates for the nonlinear signal distortion. In a case where the physical parameters are known, the physical parameters may be set in the SOA distortion compensation unit 215.

The SOA distortion compensation unit 215 calculates the gain coefficient h(t) of the nonlinear signal distortion generated in the optical signal input to the semiconductor optical amplifier 23 by the semiconductor optical amplifier 23 based on the estimated values of the physical parameters of the semiconductor optical amplifier 23. The SOA distortion compensation unit 215 calculates a value (exp((−h(t)(1+jα))/2)) representing the inverse characteristic of the gain coefficient h(t) of the nonlinear signal distortion using the gain coefficient −h(t) of the inverse characteristic of the gain coefficient h(t) of the nonlinear signal distortion. The SOA distortion compensation unit 215 multiplies the optical signal input to the semiconductor optical amplifier 23 by a value (exp((−h(t)(1+jα))/2)) representing the inverse characteristic of the gain coefficient h(t) of the nonlinear signal distortion. As a result, the SOA distortion compensation unit 215 can pre-equalize the nonlinear signal distortion generated in the optical signal input to the semiconductor optical amplifier 23.

The relationship between the optical signal acquired by the semiconductor optical amplifier 23 and the optical signal output by the semiconductor optical amplifier 23 is represented by a physical model shown in Expression (1) (see Non Patent Literature 3 and Non Patent Literature 4).

$$\begin{matrix}[ Math . 1 ] & \\ {E}_{o} ( t ) = {E}_{I} ( t ) exp ( \frac{h ( t ) ( 1 + j α )}{2} ) & ( 1 )\end{matrix}$$

Here, E₁(t) represents the complex amplitude of the optical signal (the optical modulated signal output from the optical modulation unit 222) acquired by the semiconductor optical amplifier 23. E_{O}(t) represents the complex amplitude of the optical signal transmitted by the semiconductor optical amplifier 23. h(t) represents a gain coefficient. α represents a linewidth-enhancement factor. j represents an imaginary unit. exp(h(t)(1+jα)/2) represents nonlinear signal distortion generated in the optical modulated signal by the semiconductor optical amplifier 23.

In the physical model illustrated in Expression (1), the gain coefficient h(t) is expressed by the differential equation illustrated in Expression (2).

$$\begin{matrix}[ Math . 2 ] & \\ {τ}_{c} \frac{d}{dt} h ( t ) = {h}_{0} - h ( t ) - [ exp ( h ( t ) ) - 1 ] \frac{{\vert {E}_{I} ( t ) \vert}^{2}}{{P}_{sat}} & ( 2 )\end{matrix}$$

Here, τ_{c} represents a carrier lifetime. h₀ represents a non-saturation gain. Pₛₐₜ represents a saturation output. These are physical parameters of the semiconductor optical amplifier 23, as well as the linewidth-enhancement factor α shown in Expression (1). In the physical model illustrated in Expression (1), when these physical parameters are obtained, the behavior of the nonlinear signal distortion generated in the transmission signal by the semiconductor optical amplifier 23 can be expressed.

Expression (2) shows that the temporal change of the gain coefficient h(t) depends on the power of the optical signal acquired by the semiconductor optical amplifier 23. Therefore, when the physical parameters of the semiconductor optical amplifier 23 are known, the gain coefficient h(t) depending on the power of the optical signal can be obtained from Expression (2).

The SOA distortion compensation unit 215 can obtain the gain coefficient h(t) as a numerical solution from Expression (2) by, for example, a time evolution solution method using the Euler method or the Nth-order (N is a positive integer) Runge-Kutta method. When obtaining the gain coefficient h(t) from Expression (2), the SOA distortion compensation unit 215 may use an analysis solution when there is an analysis solution.

The SOA distortion compensation unit 215 calculates a value (exp(−h(t)(1+jα)/2)) representing the inverse characteristic of the gain coefficient h(t) of the nonlinear signal distortion using the gain coefficient (−h(t)) having the inverse characteristic of the gain coefficient h(t).

The SOA distortion compensation unit 215 compensates for the nonlinear signal distortion generated in the optical modulated signal in the semiconductor optical amplifier 23 by multiplying the optical modulated signal E₁(t) by a value (exp(−h(t)(1+jα)/2)) representing the inverse characteristic of the gain coefficient h(t) of the nonlinear signal distortion. As a result, the SOA distortion compensation unit 215 can pre-equalize the nonlinear signal distortion generated in the optical modulated signal by the semiconductor optical amplifier 23.

Note that the SOA distortion compensation unit 215 may obtain the gain coefficient h(t) from Expression (2) by a solution other than the time evolution solution method. In a case where the physical parameters of the semiconductor optical amplifier 23 are not estimated, the SOA distortion compensation unit 215 may have a configuration in which the gain coefficient h(t) is set to 0 and the nonlinear signal distortion generated in the optical modulated signal in the semiconductor optical amplifier 23 is not compensated. In a case where the physical parameters of the semiconductor optical amplifier 23 are not estimated, the modulated signal output from the signal generation unit 211 may bypass the SOA distortion compensation unit 215 and may not compensate for nonlinear signal distortion generated in the optical modulated signal in the semiconductor optical amplifier 23.

The SOA distortion estimation unit 434 acquires a reception signal, which is a digital signal based on the transmission signal of the optical transmitter 2, from the analog-to-digital conversion unit 431. The SOA distortion estimation unit 434 acquires the transmission signal of the optical transmitter 2 from the optical transmitter 2 as a reference signal. For example, the SOA distortion estimation unit 434 acquires a transmission signal of the optical transmitter 2 from the optical transmitter 2 as a reference signal via the control channel 5 which is a communication channel (see Non Patent Literature 5), a network element-operations systems (NE-OpS), a network-operations system (NW-OpS), or the like. For example, the SOA distortion estimation unit 434 acquires the known signal of a part of the transmission data sequence from the optical transmitter 2 as a reference signal. For example, the SOA distortion estimation unit 434 acquires a sequence of values of symbols of the received signal from the optical transmitter 2 as a reference signal.

The SOA distortion estimation unit 434 obtains a value (exp(h(t)(1+jα)/2)) representing nonlinear signal distortion generated in the transmission signal by the semiconductor optical amplifier 23 and the linewidth-enhancement factor α as in Expression (3) based on a result of dividing the measured optical signal E_{O}(t) by the optical signal E_{I}(t) and based on Expression (1).

$$\begin{matrix}[ Math . 3 ] & \\ \frac{{E}_{o} ( t )}{{E}_{I} ( t )} = exp ( \frac{h ( t ) ( 1 + j α )}{2} ) & ( 3 )\end{matrix}$$

The SOA distortion estimation unit 434 may calculate an average value of the same symbol using the reference signal as a repeated signal. As a result, the SOA distortion estimation unit 434 can reduce signal distortion due to white noise. The SOA distortion estimation unit 434 can increase the estimation accuracy of the nonlinear signal distortion.

In a case where the nonlinear signal distortion due to the semiconductor optical amplifier 23 is large, the SOA distortion estimation unit 434 may not be capable of accurately estimating the nonlinear signal distortion due to deterioration in signal quality. The SOA distortion estimation unit 434 may feed back an estimated value once and repeat the estimation. As a result, the SOA distortion estimation unit 434 can compensate for the transfer function with higher accuracy in the case where the nonlinear signal distortion due to the semiconductor optical amplifier 23 is large.

The measured values of the physical parameters of the semiconductor optical amplifier 23 may be different from the design values of the physical parameters of the semiconductor optical amplifier 23 due to an individual difference caused by a manufacturing error or the like of the semiconductor optical amplifier 23. Therefore, the physical parameter estimation unit 435 estimates the physical parameters of the semiconductor optical amplifier 23 by digital signal processing. As a result, the SOA distortion compensation unit 215 of the optical transmitter 2 can compensate for nonlinear signal distortion by absorbing the individual difference of the semiconductor optical amplifier 23 of the optical transmitter 2. The SOA distortion estimation unit 434 can also compensate for nonlinear signal distortion for the semiconductor optical amplifier 23 having an unknown physical parameter. The physical parameter estimation unit 435 estimates the physical parameters of the semiconductor optical amplifier 23 based on a result of the SOA distortion estimation unit 434 estimating the nonlinear signal distortion according to the reference signal.

The physical parameter estimation unit 435 estimates the physical parameters of the semiconductor optical amplifier 23 according to the gain coefficient h(t) obtained using Expression (3) and according to Expression (2). The physical parameters of the semiconductor optical amplifier 23 are, for example, a carrier lifetime τ_{c}, a non-saturation gain h₀, and a saturation output Pₛₐₜ.

The method by which the physical parameter estimation unit 435 estimates the physical parameters of the semiconductor optical amplifier 23 is not limited to a specific method. For example, the physical parameter estimation unit 435 may estimate the physical parameters of the semiconductor optical amplifier 23 by fitting using a least-squares method or by calculation using simultaneous equations, or the like.

The physical parameter estimation unit 435 feeds back the physical parameters of the semiconductor optical amplifier 23 to the SOA distortion compensation unit 215 through a control channel 5 such as a communication channel (see Non Patent Literature 5), NE-OpS, or NW-OpS.

Note that, in a case where the optical transmitter 2 and the optical receiver 4 are directly connected by a dedicated line, the physical parameter estimation unit 435 may estimate the physical parameters of the semiconductor optical amplifier 23 based on an optical signal transmitted through the dedicated line instead of the transmission path 3. After estimating the physical parameters of the semiconductor optical amplifier 23, the physical parameter estimation unit 435 can send the resultant signal, in which the reference signal is removed from the transmitted signal to which the reference signal is added, to the optical transmitter 2 and the decoding unit 432. Thereafter, in a case where it is necessary to estimate the physical parameter again, the physical parameter estimation unit 435 may add the reference signal to the transmission signal again. In a case where the current injected into the semiconductor optical amplifier 23 does not change or in a case where the intensity of the optical signal acquired by the semiconductor optical amplifier 23 does not change, the physical parameter estimation unit 435 can continuously use the estimation result of the physical parameters of the semiconductor optical amplifier 23. In these cases, the physical parameter estimation unit 435 may temporarily stop the estimation of the physical parameters of the semiconductor optical amplifier 23, or may continuously and periodically calculate the physical parameters of the semiconductor optical amplifier 23. In a case where the current injected into the semiconductor optical amplifier 23 changes or in a case where the intensity of the optical signal acquired by the semiconductor optical amplifier 23 changes, the physical parameter estimation unit 435 calculates the physical parameters of the semiconductor optical amplifier 23 again.

As described above, the optical transmitter 2 according to the third embodiment can compensate for the distortion due to the semiconductor optical amplifier 23 with respect to the modulated signal generated by the signal generation unit 211, and can further reduce the influence of the nonlinear distortion caused by the semiconductor optical amplifier.

The SOA distortion estimation unit 434 and the physical parameter estimation unit 435 are not limited to being included in the digital signal processing unit 43. For example, the physical parameter estimation unit 435 or both the SOA distortion estimation unit 434 and the physical parameter estimation unit 435 may be included in the corresponding digital signal processing unit 21, and the digital signal processing unit 43 and the digital signal processing unit 21 may transmit and receive signals through the control channel 5.

Further, the SOA distortion compensation unit is not limited to being included in the digital signal processing unit 21. For example, the decoding unit 432 of the digital signal processing unit 43 may include the SOA distortion compensation unit, and the signal converted by the analog-to-digital conversion unit 431 may be multiplied by a value (exp(−h(t)(1+jα)/2)) representing the inverse characteristic of the gain coefficient h(t) of the nonlinear signal distortion to compensate for the nonlinear signal distortion generated in the transmission signal in the semiconductor optical amplifier 23.

The SOA distortion compensation unit 215 and the SOA distortion compensation unit included in the decoding unit 432 may also compensate for the nonlinear signal distortion caused by the semiconductor optical amplifier 41 included in the optical receiver 4 similarly to the nonlinear signal distortion caused by the semiconductor optical amplifier 23.

### Experimental Example

Hereinafter, an experimental example in the configuration of FIG. 2 of the first embodiment will be described. In the experimental example, the symbol rates of the broadband optical modulated signals input from the optical modulation unit 222 of the optical transmitter 2 to the semiconductor optical amplifier 23 are 42 GBd, 84 GBd, and 168 GBd. The modulation method is polarization multiplexing 16 quadrature amplitude modulation (QAM) with stochastic constellation shaping. In addition, the current injected into the semiconductor optical amplifier 23 is changed to change the amplification factor.

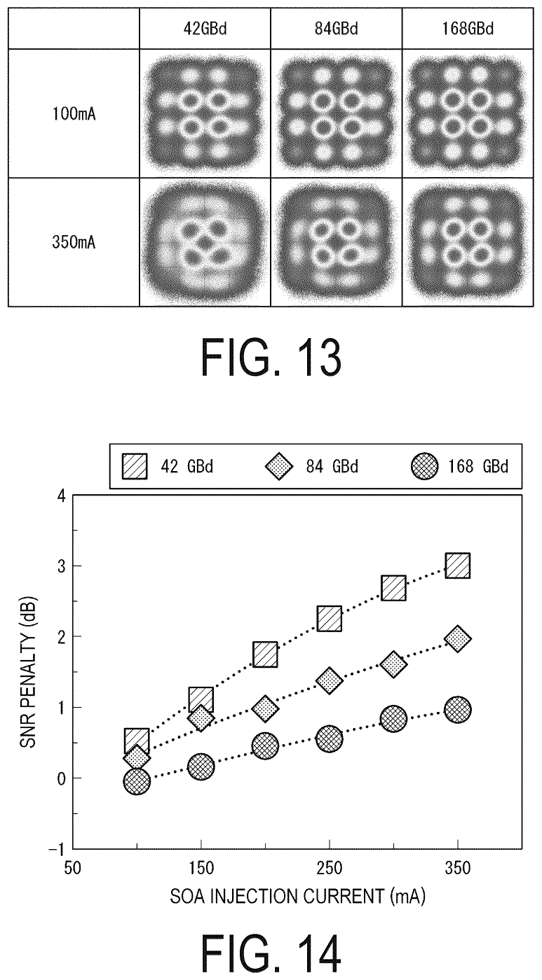

FIG. 13 is a table illustrating a constellation diagram under each condition. The six constellation diagrams illustrated in FIG. 13 are constellation diagrams illustrating signals output from the optical transmitter 2 when the currents injected into the semiconductor optical amplifier 23 are set to 100 mA and 350 mA, and the symbol rates of the broadband optical modulated signals are set to 42 GBd, 84 GBd, and 168 GBd. It has been confirmed that the symbol rate of the optical modulated signal increases from 42 GBd to 84 GBd and from 84 GBd to 168 GBd, so that the boundary between the signal points becomes clear, and the nonlinear distortion caused by the semiconductor optical amplifier is reduced, particularly when the injection current is 350 mA.

In addition, the dependency of the injection current into the semiconductor optical amplifier is indicated by setting a difference as an SNR penalty between the SN ratio of the optical signal output from the semiconductor optical amplifier 23 of the optical transmitter 2 and the SN ratio of the optical signal output from an Erbium Doped Fiber Amplifier (EDFA) in a case where the semiconductor optical amplifier 23 of the optical transmitter is replaced with the EDFA.

FIG. 14 is a graph illustrating a relationship between a magnitude of an injection current (SOA injection current) into the semiconductor optical amplifier and an SNR penalty. When the SOA injection current was 350 mA, the SNR penalty for the symbol rate of the optical modulated signal of 168 GBd was about 2 dB less than the SNR penalty for the symbol rate of 42 GBd, and about 1 dB less than the SNR penalty for the symbol rate of 84 GBd. Therefore, it is shown that by using the optical modulated signal of a high symbol rate, the nonlinear distortion caused by the semiconductor optical amplifier is reduced particularly when the amplification factor of the semiconductor optical amplifier is high.

### OTHER EMBODIMENTS

Although the embodiments of the present invention has been described in detail with reference to the drawings, the specific configuration is not limited to the above, and various design changes and the like can be made without departing from the gist of the present invention.

In the above embodiment, the signal generation unit 211 generates a modulated signal sequence (I(n), Q(n)) which is an electrical signal indicating an in-phase component and a quadrature component of the optical signal, but the present invention is not limited thereto. For example, an electrical signal (XI(n), XQ(n), YI(n), YQ(n)) indicating in-phase components and orthogonal components of the X-polarized wave and the Y-polarized wave of the optical signal may be generated using the polarized wave of the optical signal.

In the first embodiment, the semiconductor optical amplifier 23 of the optical transmitter 2 amplifies the intensity of the optical modulated signal generated by the optical modulation unit 222, but the present invention is not limited thereto. The semiconductor optical amplifier 23 may be provided between the optical modulation unit 222 and the signal light source 223, amplify the signal light input from the signal light source 223, and output the signal light to the optical modulation unit 222. In addition, when there are different signals depending on the X-polarized wave and the Y-polarized wave of the optical signal, the semiconductor optical amplifier 23 may amplify only one of the X-polarized component or the Y-polarized component and be included in the optical modulation unit 222, or a plurality of the semiconductor optical amplifier 23 may amplify both of the X-polarized component or the Y-polarized component and be included in the optical modulation unit 222.

In the first embodiment, the semiconductor optical amplifier 41 of the optical receiver 4 amplifies the intensity of the optical signal input to the optical receiver 4, but the present invention is not limited thereto. When there are different signals depending on the X-polarized wave and the Y-polarized wave of the optical signal, the semiconductor optical amplifier 41 may amplify only one of the X-polarized component or the Y-polarized component and included in the photoelectric conversion unit 421, or a plurality of the semiconductor optical amplifier 41 may amplify both of the X-polarized component or the Y-polarized component and be included in the photoelectric conversion unit 421.

The optical transmitter 2 and the optical receiver 4 may be realized by the same device. At this time, the signal light source 223 and the local light emission source 422 may be the same light source.

In the first and second embodiments, the configuration example in which the IQ modulated signal is handled has been described, but a configuration example in which the intensity modulated signal is handled may be used. In this case, the 90 degree optical hybrid constituting the photoelectric conversion unit 421 and the local light emission source 422 can be omitted.

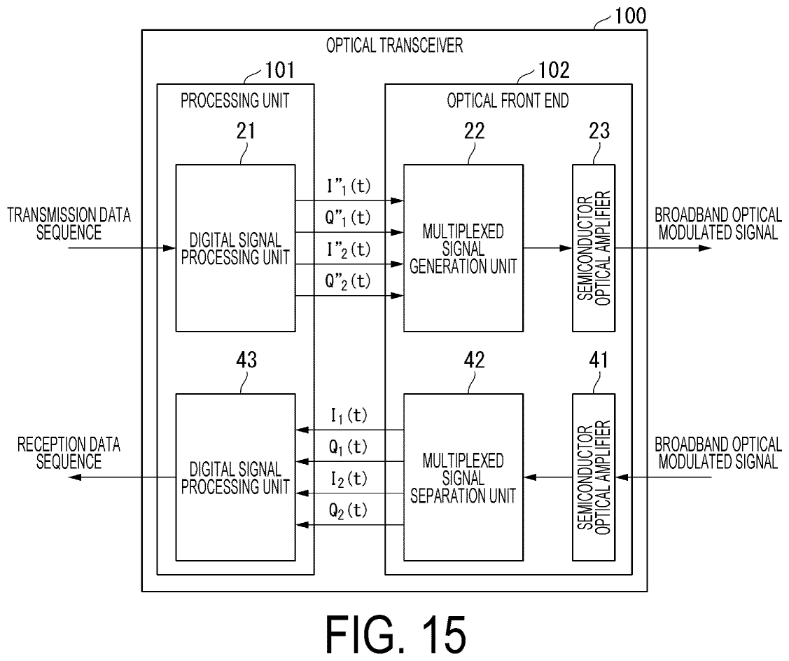

FIG. 15 is a diagram illustrating an optical transceiver 100 according to the present embodiment. The optical transceiver 100 includes a processing unit 101 and an optical front end 102. The processing unit 101 includes the digital signal processing unit 21 and the digital signal processing unit 43. The optical front end 102 includes the multiplexed signal generation unit 22, the semiconductor optical amplifier 23, the semiconductor optical amplifier 41, and the multiplexed signal separation unit 42. The multiplexed signal generation unit 22, the semiconductor optical amplifier 23, the semiconductor optical amplifier 41, and the multiplexed signal separation unit 42 constituting the optical front end 102 may have an integrated configuration. The signal light source 223 may be integrated in the optical front end 102. The multiplexed signal separation unit 42 may not include the local light emission source 422, and may branch the signal light source 223 to have the function of the local light emission source 422.

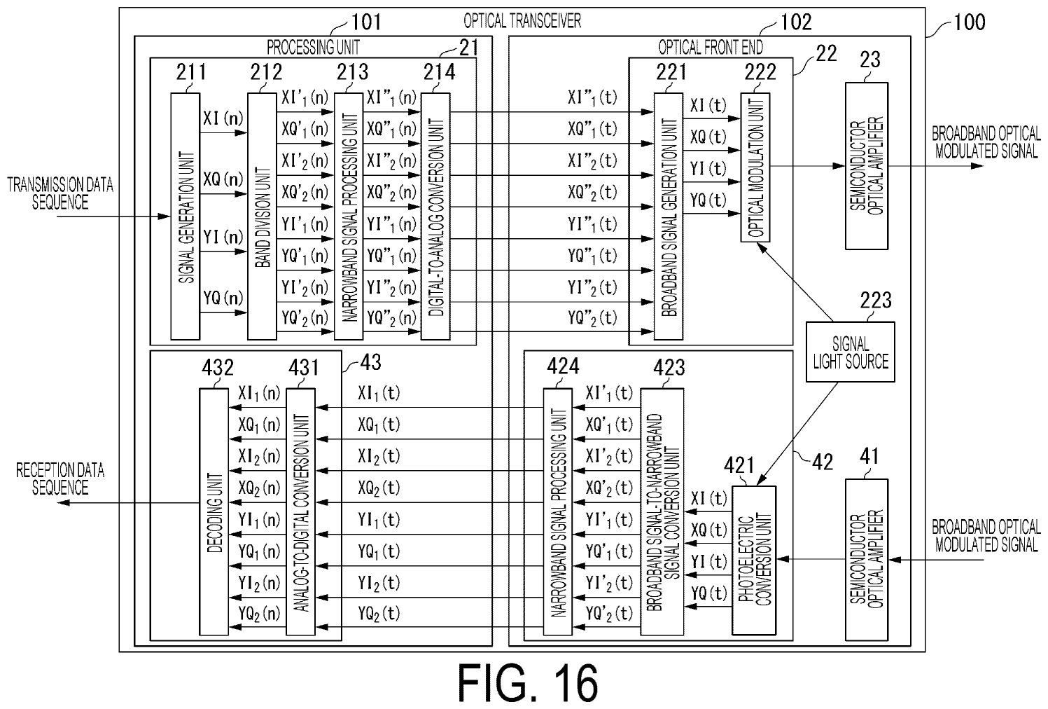

Note that, as described above, the optical transceiver 100 may perform communication using the polarized wave of the optical signal, specifically, may perform communication using an electrical signal (XI(n), XQ(n), YI(n), YQ(n)) indicating in-phase components and orthogonal components of the X-polarized wave and the Y-polarized wave of the optical signal. FIG. 16 is a diagram illustrating an optical transceiver 100 that performs polarization multiplexing according to the present embodiment.

As illustrated in FIG. 16, in the digital signal processing unit 21, the signal generation unit 211 generates an electrical signal (XI(n), XQ(n), YI(n), YQ(n)) indicating in-phase components and orthogonal components of the X-polarized wave and the Y-polarized wave of the optical signal, and the band division unit 212, the narrowband signal processing unit 213, and the digital-to-analog conversion unit 214 independently process the electrical signal related to the X-polarized wave and the electrical signal related to the Y-polarized wave, respectively. In the multiplexed signal generation unit 22, the broadband signal generation unit 221 independently processes the electric signal related to the X-polarized wave and the electric signal related to the Y-polarized wave, respectively, and the optical modulation unit 222 generates an optical signal by performing polarization synthesis in addition to optical modulation.

In addition, in the multiplexed signal separation unit 42, the photoelectric conversion unit 421 polarization-separates the optical signal and then performs photoelectric conversion to generate a broadband signal related to the X-polarized wave and the Y-polarized wave. The broadband signal-to-narrowband signal conversion unit 423, the narrowband signal processing unit 424, and the analog-to-digital conversion unit 431 process the electric signal related to the X-polarized wave and the electric signal related to the Y-polarized wave independently, respectively. The decoding unit 432 decodes the electric signal related to the X-polarized wave and the electric signal related to the Y-polarized wave to generate a reception data sequence.

Note that the multiplexed signal generation unit 22, the semiconductor optical amplifier 23, the semiconductor optical amplifier 41, and the multiplexed signal separation unit 42 may be integrated to constitute the optical front end 102. The signal light source 223 may be integrated in the optical front end 102.

### REFERENCE SIGNS LIST

1 Optical transmission system
2 Optical transmitter
3 Transmission path
4 Optical receiver
21 Digital signal processing unit
211 Signal generation unit
212 Band division unit
213 Narrowband signal processing unit
214 Digital-to-analog conversion unit
22 Multiplexed signal generation unit
221 Broadband signal generation unit
222 Optical modulation unit
223 Signal light source
224 Wavelength multiplexing unit
23, 41 Semiconductor optical amplifier
42 Multiplexed signal separation unit
421 Photoelectric conversion unit
422 Local light emission source
423 Broadband signal-to-narrowband signal conversion unit
424 Narrowband signal processing unit
425 Wavelength demultiplexing unit

1. An optical transmitter comprising:
a multiplexed signal generation unit that multiplexes a plurality of narrowband signals and generates a broadband optical modulated signal; and
a semiconductor optical amplifier that amplifies an intensity of the broadband optical modulated signal.

2. The optical transmitter according to claim 1, wherein the multiplexed signal generation unit includes:
a broadband signal generation unit that generates a broadband signal having a wider frequency band than the narrowband signal from the plurality of narrowband signals; and
an optical modulation unit that modulates an optical signal based on the broadband signal and generates the broadband optical modulated signal.

3. The optical transmitter according to claim 1, wherein the multiplexed signal generation unit includes:
a plurality of optical modulation units that modulates an optical signal based on the narrowband signal and generates an optical modulated signal; and
a wavelength multiplexing unit that multiplexes the plurality of optical modulated signals to generate the broadband optical modulated signal.

4. The optical transmitter according to claim 1 further comprising
a distortion compensation unit that compensates for distortion of the broadband optical modulated signal due to the semiconductor optical amplifier.

5. An optical receiver comprising:
a semiconductor optical amplifier that amplifies an intensity of a broadband optical modulated signal; and
a multiplexed signal separation unit that separates the broadband optical modulated signal into a narrowband signal.

6. The optical receiver according to claim 5, wherein the multiplexed signal separation unit includes:
a photoelectric conversion unit that converts the amplified broadband optical modulated signal into an electric signal; and
a broadband signal-to-narrowband signal conversion unit that separates the electrical signal based on a band.

7. The optical receiver according to claim 5, wherein the multiplexed signal separation unit includes:
a wavelength demultiplexing unit that demultiplexes the amplified broadband optical modulated signal and generates a narrowband optical modulated signal; and
a photoelectric conversion unit that converts the narrowband optical modulated signal into a narrowband signal.

8. The optical receiver according to claim 6 further comprising
an SOA distortion compensation unit that compensates for distortion of the broadband optical modulated signal due to the semiconductor optical amplifier.

9. An optical transmission method comprising:
a multiplexed signal generation step of multiplexing a plurality of narrowband signals and generating a broadband optical modulated signal; and
a semiconductor optical amplification step of amplifying an intensity of the broadband optical modulated signal.

10. (canceled)
